(19) United States
(12) Patent Application Publication
(10) Pub. No.: US 2025/0102670 A1
(43) Pub. Date: Mar. 27, 2025

(54) DISTANCE MEASURING APPARATUS AND METHOD OF CONTROLLING THE SAME

(71) Applicant: VC INC., Seoul (KR)

(72) Inventors: YURI HWANG, Seoul (KR); Juno KIM, Seoul (KR); Kichool PARK, Seoul (KR)

(21) Appl. No.: 18/891,167

(22) Filed: Sep. 20, 2024

(30) Foreign Application Priority Data
Sep. 21, 2023 (KR) 10-2023-0126509

(51) Int. Cl. G01S 17/08

(52) U.S. Cl. CPC G01S 17/08

(57) ABSTRACT

Disclosed is a distance measuring apparatus including: a user input unit for receiving a first user input and a second user input; a hand tremor sensor for detecting a hand tremor of a user based on the first user input, and measuring a hand tremor period of the user; and a distance measurement sensor for determining a first laser output section based on the hand tremor period, and for outputting a laser during the first laser output section based on the second user input.

### CROSS-REFERENCE TO RELATED APPLICATION

This application claims priority to and the benefit of Korean Patent Application No. 10-2023-0126509 filed in the Korean Intellectual Property Office on Sep. 21, 2023, the entire contents of which are incorporated herein by reference.

### BACKGROUND OF THE INVENTION

The present disclosure relates to a distance measuring apparatus and a method of controlling the same.

Golf is a sport in which golfers hit a golf ball with a variety of clubs in order to get the golf ball into a hole, and compete for supremacy by the number of shots it takes to get the golf ball into the hole.

A golfer playing a round on the field must consider many factors to hit a good shot, the most important of which is distance information, which indicates the distance from the position of the golf ball to the pin or desired target point. That is, when a golfer knows the exact distance from the position of the golf ball to the pin or desired target point, the golfer may choose the right club and control the strength of the shot.

One method to measure a distance in the field is a method of measuring a distance by using laser. In the method of measuring a distance by using laser, a laser is directed at a target and the distance to the target is measured by measuring the time it takes for a portion of the laser to reflect back to the target. However, the tremor of the user's hand using the distance measuring apparatus may make it difficult to accurately aim the laser at the target.

### SUMMARY OF THE INVENTION

The present disclosure attempts to provide a distance measuring apparatus for measuring the period of hand tremor of a user and adjusting an output section of a laser according to the period of the hand tremor, and a method of controlling the same.

The present disclosure attempts to provide a distance measuring apparatus, which adjusts an output section of a laser in accordance with a period of hand tremor of a user, thereby making it easier for a golfer to aim the laser at a target, and a method of controlling the same.

An exemplary embodiment of the present disclosure provides a distance measuring apparatus including: a user input unit for receiving a first user input and a second user input; a hand tremor sensor for detecting a hand tremor of a user based on the first user input, and measuring a hand tremor period of the user; and a distance measurement sensor for determining a first laser output section based on the hand tremor period, and for outputting a laser during the first laser output section based on the second user input.

The laser output section may be equal to or longer than the hand tremor period.

The distance measurement sensor may perform a distance measurement to a target point during a predetermined time section based on the second user input, the predetermined time section includes the first laser output section, a plurality of laser non-output sections in which the laser is not output, and a plurality of second laser output section in which the laser is output, and the plurality of laser non-output sections and the plurality of second laser output sections may be alternating.

A sum of time lengths of the first laser output section and the plurality of second laser output sections may be predetermined, the number of the plurality of second laser output sections repeated within the predetermined time section may be predetermined, and the time length of the plurality of second laser output sections may be shorter than the time length of the first laser output section.

A sum of time lengths of the first laser output section and the plurality of second laser output sections may be predetermined, the number of the plurality of second laser output sections repeated within the predetermined time section may be predetermined, and the time length of the plurality of second laser output sections may be equal to the time length of the first laser output section.

Based on said hand tremor of the user, the hand tremor sensor may further measure a hand tremor angle.

The distance measurement sensor may measure a distance to the target point based on a time for which at least one of output pulses of the laser output in the first laser output section is reflected back from the target point and the hand tremor angle.

The distance measuring apparatus may further include a memory for storing the hand tremor period.

When the user input unit receives the second user input again before a second time section elapses after the predetermined time section, the distance measurement sensor may re-determine the first laser output section based on the hand tremor period stored in the memory, and re-output a laser during the first laser output section based on the re-input second user input.

Another exemplary embodiment of the present disclosure provides a distance measuring method including: receiving a first user input; detecting an aiming direction of a distance measuring apparatus based on the first user input; based on the aiming direction, detecting a hand tremor of a user, and measuring a hand tremor period at a first predetermined period; determining a first laser output section based on the hand tremor period; receiving a second user input; outputting a laser during a plurality of laser output sections including the first laser output section based on the second user input; and measuring a distance to the target point based on a time for the output laser to reflect back from the target point.

The determining of the first laser output section based on the hand tremor period may include: determining a time length equal to the hand tremor period or greater than the hand tremor period as the first laser output section; and determining a time length of the remaining output sections among the plurality of laser output sections, except for the first laser output section.

The outputting of the laser during the plurality of laser output sections including the first laser output section based on the second user input may include outputting the laser during the first laser output section, and alternating with a plurality of laser non-output sections in which the laser is not output and the remaining output sections, within a predetermined time section.

The remaining output sections may be the same as the first laser output section.

The distance measuring method may further include measuring a tilt and an azimuth of the distance measuring apparatus at a second predetermined period different from the first predetermined period.

The first predetermined period may be shorter than the second predetermined period.

The distance measuring method may further include measuring a hand tremor angle based on the hand tremor of the user.

The distance measuring method may further include: receiving a second user input again; determining when the re-received second user input is an input within a predetermined time section after the distance measurement; and when it is determined that the re-received second user input is an input within a predetermined time section after the distance measurement, re-determining the first laser output section based on the hand tremor period.

Still exemplary embodiment of the present disclosure provides a distance measuring apparatus for measuring a distance to a target point, the distance measuring apparatus including: a sensing unit for detecting a hand tremor of a user at a first period, measuring a hand tremor period and a hand tremor angle, and measuring a tilt of the distance measuring apparatus at a second period different from the first period; and a distance measurement sensor for repeating a plurality of laser output sections of outputting a laser and a plurality of laser non-output sections of not outputting a laser for a predetermined measurement time, a first output section of the plurality of laser output sections including the hand tremor period, measuring a straight line distance to the target point based on a time for a laser output in the plurality of laser output sections to reflect back from the target point, and measuring a height distance to the target point based on the tilt and the hand tremor angle.

A sum of time lengths of the plurality of laser output sections repeated for the predetermined measurement time may be predetermined.

A time length of the first output section of the plurality of laser output sections and a time length of the remaining output sections except for the first output section of the plurality of laser output sections may be different from each other.

The first period may be shorter than the second period.

The effectiveness of the distance measuring apparatus and the method of controlling the same according to the present disclosure is described as follows.

According to at least one of the exemplary embodiments of the present disclosure, there is the advantage in that a golfer is capable of easily aiming the laser at the target.

According to at least one of the exemplary embodiments of the present disclosure, there is the advantage in that a golfer is capable of easily determining a distance to the hole.

The additional scope of applicability of the present disclosure will become apparent from the following detailed description. However, it should be understood that the detailed description and specific exemplary embodiments, such as the exemplary embodiment of the present disclosure, are given by way of illustration only, since various changes and modifications within the scope of the present disclosure may be clearly understood by those skilled in the art.

### BRIEF DESCRIPTION OF THE DRAWINGS

FIG. 1 is a block diagram illustrating a distance measuring apparatus according to an exemplary embodiment.

FIGS. 2 and 3 are conceptual diagrams of an example of the distance measuring apparatus according to the exemplary embodiment, viewed from different directions.

FIG. 4 is a schematic structural diagram of the distance measuring apparatus according to the exemplary embodiment.

FIG. 5 is a diagram for illustrating an output section and output period of the laser output from the distance measuring apparatus.

FIGS. 6 and 7 are diagrams illustrating a target point and a target displayed on the distance measuring apparatus.

FIG. 8 is a diagram illustrating a laser output from the distance measuring apparatus 100 and a distance measuring method based on the output laser according to a comparative example.

FIG. 9 is a diagram illustrating a distance measuring method of the distance measuring apparatus according to an exemplary embodiment.

FIG. 10 is a diagram illustrating a laser output from the distance measuring apparatus and a distance measuring method based on the output laser according to an exemplary embodiment.

FIG. 11 is a diagram illustrating a laser output from the distance measuring apparatus and a distance measuring method based on the output laser according to an exemplary embodiment.

FIG. 12 is a diagram illustrating a distance measuring method of the distance measuring apparatus according to another exemplary embodiment.

### DETAILED DESCRIPTION OF THE EXEMPLARY EMBODIMENTS

Hereinafter, an exemplary embodiment disclosed the present specification will be described in detail with reference to the accompanying drawings, and the same or similar constituent factor is denoted by the same reference numeral regardless of a reference numeral, and a repeated description thereof will be omitted. Suffixes, “module” and and/or “unit” for a component used for the description below are given or mixed in consideration of only easiness of the writing of the specification, and the suffix itself does not have a discriminated meaning or role. Further, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinary number, such as first and second, are used for describing various components, but the components are not limited by the terms. The terms are used only to discriminate one component from another component.

It should be understood that when one constituent element referred to as being “coupled to” or “connected to” another constituent element, one constituent element may be directly coupled to or connected to the other constituent element, but intervening elements may also be present. In contrast, when one constituent element is “directly coupled to” or “directly connected to” another constituent element, it should be understood that there are no intervening element present.

In the present application, it will be appreciated that terms “including” and “having” are intended to designate the existence of characteristics, numbers, operations, operations, components, and components described in the specification or a combination thereof, and do not exclude a possibility of the existence or addition of one or more other characteristics, numbers, operations, operations, components, and components, or a combination thereof in advance.

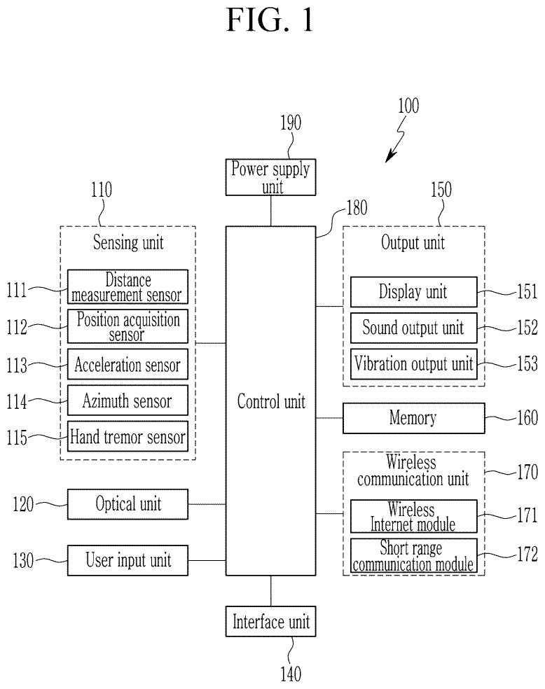

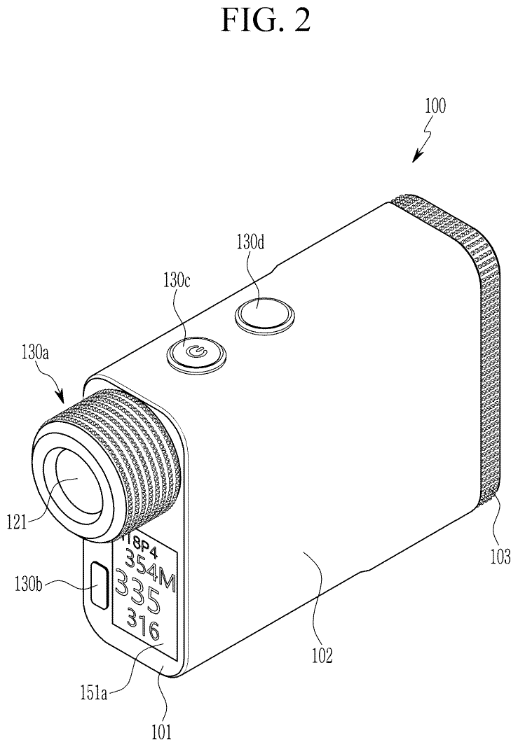

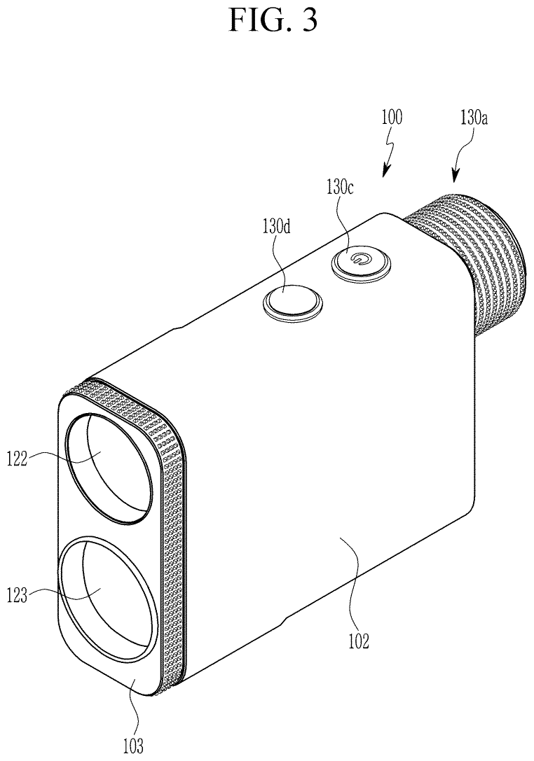

FIG. 1 is a block diagram illustrating a distance measuring apparatus 100 according to an exemplary embodiment, and FIGS. 2 and 3 are conceptual diagrams of an example of the distance measuring apparatus 100 according to the exemplary embodiment, viewed from different directions.

The distance measuring apparatus 100 may include a sensing unit 110, an optical unit 120, a user input unit 130, an interface unit 140, an output unit 150, a memory 160, a wireless communication unit 170, a control unit 180, a power supply unit 190, and the like. The components illustrated in FIG. 1 are not essential to implement the distance measuring apparatus 100, and the distance measuring apparatus 100 described in the present specification may have more or fewer components than those listed above.

More specifically, among the components, the sensing unit 110 may include one or more sensors for sensing at least one of neighboring environmental information surrounding the distance measuring apparatus 100 and information within the distance measuring apparatus 100. For example, the sensing unit 110 may include at least one of a distance measurement sensor 111, a position acquisition sensor 112, an acceleration sensor 113, an acceleration sensor, an azimuth sensor 114, a hand tremor sensor 115, a gyroscope sensor, a battery gauge, an environmental sensor (e.g., a barometer, a hygrometer, and a thermometer), and an ambient Light Sensor. The ambient Light Sensor may detect external brightness and adjust the brightness of a display unit (including a target indicator). In the meantime, the distance measuring apparatus 100 disclosed in the present specification may utilize a combination of information sensed by at least two of these sensors.

First, the distance measurement sensor 111 refers to a sensor that measures the distance to a target. The distance measurement sensor 111 may include an ultrasonic sensor, an infrared sensor (IR sensor), a laser sensor, a radio detecting and ranging sensor (radar sensor), an optical sensor (e.g., a camera), or the like. The distance measurement sensor 111 is not limited to the types of sensors listed above, but may include any type of sensor that measures the distance to a target.

Hereinafter, the description will be given on an assumption that the distance measurement sensor 111 is a laser sensor that transmits a laser forward, receives the laser reflected by a target, and measures the distance to a target.

The position acquisition sensor 112 is a sensor for acquiring the position of the distance measuring apparatus 100, a representative example of which is a global positioning system (GPS) sensor. By calculating distance information and precise time information from three or more satellites, and then applying trigonometry to the calculated information, a GPS sensor may accurately calculate three-dimensional current position information based on latitude, longitude, and altitude. Currently, the method of calculating position and time information by using three satellites and correcting errors in the calculated position and time information by using one satellite is widely used. In addition, the GPS sensor may calculate speed information by continuously calculating the current position in real time.

The acceleration sensor 113 may acquire a degree of tilt of the distance measuring apparatus 100. The acceleration sensor 113 may include an accelerometer to measure the acceleration of gravity. Additionally, the acceleration sensor 113 may be implemented as calculating a tilt by using the angle of rotation in the up and down direction from a preset reference direction, acquired by a gyro sensor, and the like.

The azimuth sensor 114 is a sensor that measures azimuth, and may acquire a value of the azimuth that the distance measuring apparatus 100 is facing. The azimuth sensor 114 may be a geomagnetic sensor that measures azimuth by detecting the earth's magnetic field. The azimuth sensor 114 may also be implemented as calculating the azimuth by using the angle of rotation in the left and right direction from a preset reference direction acquired by the gyro sensor, and the like.

In the exemplary embodiment, the distance measuring apparatus 100 may detect the direction in which the distance measuring apparatus 100 is aimed by using the acceleration sensor 113 and the azimuth sensor 114 . . . . Specifically, when the distance measuring apparatus 100 is powered by a user, the distance measuring apparatus 100 may acquire tilt and azimuth values of the distance measuring apparatus 100 by using the acceleration sensor 113 and the azimuth sensor 114 of the distance measuring apparatus 100, and determine whether the distance measuring apparatus 100 is aiming at a target. Based on the data acquired from the acceleration sensor 113 and the azimuth sensor 114 of the distance measuring apparatus 100, when it is determined that the distance measuring apparatus 100 is aiming at a target, the distance measurement sensor 111 of the distance measuring apparatus 100 may, in response to a user input, transmit a laser forward, receive a laser reflected by the target, and measure the distance to the target.

The hand tremor sensor 115 may measure the hand tremor of a user using the distance measuring apparatus 100. Since the distance measuring apparatus 100 is operated by a human hand rather than a stationary fixture, the hand tremor of the user may reduce the accuracy of the distance information measured by the distance measuring apparatus 100. In particular, a user pressing a button may make it difficult for the distance measuring apparatus 100 to be accurately aimed at a target. The hand tremor sensor 115 may measure a hand tremor period of a user using the distance measuring apparatus 100. The hand tremor sensor 115 may measure a hand tremor angle of a user using the distance measuring apparatus 100. The distance measuring apparatus 100 may adjust an output section of the laser transmitted from the distance measurement sensor 111 based on the hand tremor period and the hand tremor angle of the user measured by the hand tremor sensor 115, and measure the distance to the target.

The optical unit 120 has a structure for receiving external light and may include a lens unit, a filter unit, and the like. The optical unit 120 optically processes light from a subject.

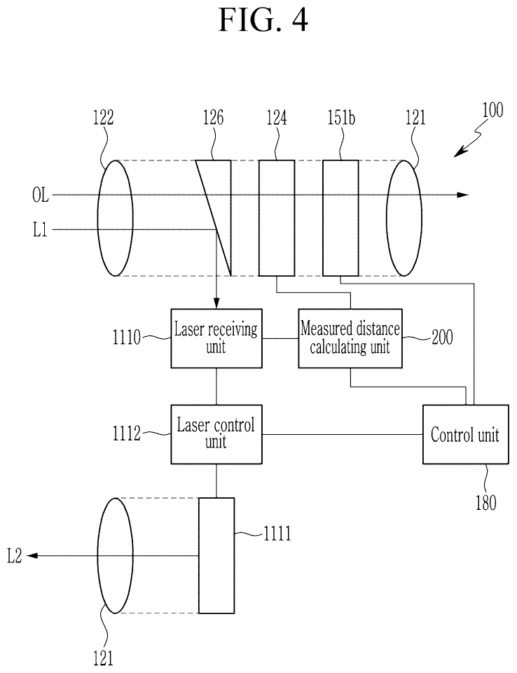

The lens unit may include a zoom lens, a focus lens, a compensate lens, and the like, and the filter unit may include an ultraviolet filter (UV filter), an optical low pass filter, and the like. A detailed description of the optical unit 120 will be described later with reference to FIG. 4.

Next, the user input unit 130 is for receiving information from a user, and when information is input via the user input unit 130, the control unit 180 may control the operation of the distance measuring apparatus 100 in response to the inputted information. As such, the user input unit 130 may include a mechanical input means (or, a mechanical key, for example, a button, a dome switch, a jog wheel, or a jog switch located on the front surface, the back surface, or the lateral surface of the distance measuring apparatus 100) and a touch-type input means. In one example, the touch-type input means may include a virtual key, soft key, or visual key displayed on a touchscreen through software processing, or a touch key disposed on a part other than the touchscreen. In the meantime, the virtual key or visual key may be displayed on the touchscreen in various forms, for example, as a graphic, text, icon, video, or a combination thereof.

In the exemplary embodiment, the distance measuring apparatus 100 may be applied with power upon receiving an input to press the user input unit 130, for example, the button, and may measure the distance between the distance measuring apparatus 100 to a target via the distance measurement sensor 111 while the user is pressing the button.

The interface unit 140 serves as a passage to various types of external devices connected to the distance measuring apparatus 100. The interface unit 140 may include at least one of an external charger port, a wired/wireless data port, and a memory 160 card port. In response to the connection of the external device to the interface unit 140, the distance measuring apparatus 100 may perform appropriate controls associated with the connected external device.

The output unit 150 is for generating an output related to visual sensation, audible sensation, tactile sensation, or the like, and may include a display unit 151, a sound output unit 152, a vibration output unit 153, and the like.

The display unit 151 displays (outputs) the information processed in the distance measuring apparatus 100. For example, the display unit 151 may display execution screen information of an application program driven in the distance measuring apparatus 100 or user interface (UI) and graphic user interface (GUI) information according to the execution screen information.

The display unit 151 may include at least one of a liquid crystal display (LCD), a thin film transistor-liquid crystal display (TFT LCD), an organic light-emitting diode (OLED), and an e-ink display.

Further, there may be two or more display units 151 depending on the implementation type of the distance measuring apparatus 100. In this case, the plurality of display units 151 may be disposed together on the outer surface of the distance measuring apparatus 100 and the inner surface of the distance measuring apparatus 100, or may be disposed separately on each of the outer surface of the distance measuring apparatus 100 and the inner surface of the distance measuring apparatus 100.

The sound output unit 152 may output audio data stored in the memory 160 as sound, and may be implemented in the form of a loud speaker outputting various alarm sounds or play sound of multimedia.

The vibration output unit 153 generates various tactile effects that may be felt by the user. The intensity and pattern of vibrations generated by the vibration output unit 153 may be controlled by user selection or settings in the control unit 180. For example, the vibration output unit 153 may synthesize and output different vibrations or sequentially output different vibrations.

In addition, the output unit 150 may also further include a light output unit outputting a signal notifying the generation of an event by using light of a light source.

The memory 160 also stores data that supports various functions of the distance measuring apparatus 100 (e.g., the data may include, but is not limited to, course map information for tee boxes, fairways, hazards, bunkers, roughs, greens, and holes on a golf course). The memory 160 according to the exemplary embodiment may store the hand tremor period information and hand tremor angle information of the user measured by the hand tremor sensor 115. The memory 160 may store firmware, application programs that run on the distance measuring apparatus 100, and data and commands for the operation of the distance measuring apparatus 100. At least some of the application programs may be present on the distance measuring apparatus 100 from the factory for basic functionality of the distance measuring apparatus 100. Further, at least some of the application programs may be downloaded from an external server through wireless communication. In the meantime, the application program may be stored in the memory 160 and is installed in the distance measuring apparatus 100 to be driven so that the operation (or function) of the distance measuring apparatus 100 is performed by the control unit 180.

Next, the wireless communication unit 170 may include one or more modules that enable wireless communication between the distance measuring apparatus 100 and a wireless communication system, between the distance measuring apparatus 100 and other wirelessly communicable devices, or between the distance measuring apparatus 100 and an external server.

The wireless communication unit 170 may include a wireless Internet module 171, a short range communication module 172, and the like.

The wireless Internet module 171 refers to a module for wireless Internet access, and may be embedded in the distance measuring apparatus 100. The wireless Internet module 171 is configured to transmit and receive wireless signals in a communication network according to wireless Internet technologies. Examples of the wireless Internet technologies include wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like, and the wireless Internet module 171 transmits and receives data according to at least one wireless Internet technology in the range including Internet technologies not listed above.

The short range communication module 172 is for short range communication and may support short range communication by using at least one of Bluetooth™ radio frequency identification (RFID), infrared data association (IrDA), ultra wideband (UWB), ZigBee, near field communication (NFC), wireless-fidelity (Wi-Fi), Wi-Fi Direct, and wireless universal serial bus (Wireless USB) technologies. As such, the short range communication module 172 may support wireless communication between the distance measuring apparatus 100 and a wireless communication system, between the distance measuring apparatus 100 and a wirelessly communicable device or the like, or between the distance measuring apparatus 100 and a network where an external server is located, via wireless area networks. The short range wireless communication network may be a short range wireless personal area network.

Here, the wirelessly communicable device may be a wearable device (for example, a smart watch and smart glasses) capable of exchanging data with (or interoperable with) the distance measuring apparatus 100 according to the present invention. The short range communication module 172 may detect (or recognize) wearable devices in the vicinity of the distance measuring apparatus 100 that are capable of communicating with the distance measuring apparatus 100. Further, the control unit 180 may transmit at least a portion of the data processed on the distance measuring apparatus 100 to the wearable device via the short range communication module 172, when the detected wearable device is a device authorized to communicate with the distance measuring apparatus 100 according to the exemplary embodiment. Thus, a user of the wearable device may use the data processed by the distance measuring apparatus 100 via the wearable device.

In addition to the operation related to the application program, the control unit 180 may generally control the general operation of the distance measuring apparatus 100. The control unit 180 may process the signal, the data, the information, and the like input or output through the foregoing components or drive the application program stored in the memory 160 to provide the appropriate information or function to the user or process the appropriate information or function.

Further, the control unit 180 may control at least some of the components described with reference to FIG. 1 in order to drive the application program stored in the memory 160. Further, the control unit 180 may operate at least two of the components included in the distance measuring apparatus 100 in combination with each other to drive the application program.

The power supply unit 190, under the control of the control unit 180, receives power from an external power source and an internal power source and provides power to each of the components included in the distance measuring apparatus 100. The power supply unit 190 includes a battery, and the battery may be an embedded battery or a replaceable battery.

At least some of each of the components may operate in cooperation with each other to implement the operation of the distance measuring apparatus 100, the control, or the control method of the distance measuring apparatus 100 according to various exemplary embodiments which will be described below. Further, the operation, the control, or the control method of the distance measuring apparatus 100 may be implemented on the distance measuring apparatus 100 for driving at least one application program stored in the memory 160.

Referring now to FIGS. 2 and 3, the disclosed distance measuring apparatus 100 has a columnar body of which a front face and a rear face are in the shape of an oval track. The distance measuring apparatus 100 may be applied to various structures, such as a watch type, a clip type, a glasses type, or a slide type in which two or more bodies are combined to be relatively movable, a swing type, and a swivel type, but the present disclosure is not limited thereto. The following description may be related to a particular type of distance measuring apparatus 100, the description of a particular type of distance measuring apparatus 100 may be generally applicable to other types of distance measuring apparatus 100.

As used herein, a body may be understood as at least one assembly because the distance measuring apparatus 100 is considered as at least one assembly.

The distance measuring apparatus 100 includes a case (for example, frame, housing, or cover) that forms its exterior. As illustrated, the distance measuring apparatus 100 may include a front case 101, a middle case 102, and a rear case 103. Various electronic components are disposed in the interior space formed by the combination of the front case 101, the middle case 102, and the rear case 103.

These cases may be formed by injection of a synthetic resin, or may be formed of metal, such as stainless steel (STS), aluminum (Al), titanium (Ti), or the like, and may be externally covered with a material, such as leather or rubber.

In the front case 101, an eyepiece 121, a first manipulation unit 130a, a second manipulation unit 130b, and a display unit 151a may be disposed. In this case, the first manipulation unit 130a may be disposed around the periphery of the eyepiece 121 in the form of a jog wheel, so that the eyepiece 121 may be protected.

The display unit 151a disposed on the outer surface of the front case 101 may include a touch sensor for detecting a touch on the display unit 151a so that control instructions may be input by a touch manner. By using this, when a touch is made on the display unit 151a, the touch sensor detects the touch, and the control unit 180 may be configured to generate a control instruction corresponding to the touch based on the detected touch. The content input by the touch manner may be letters or numbers, directions in various modes, or designable menu items.

A third manipulation unit 130c and a fourth manipulation unit 130d may be disposed on one face of the middle case 102. The user may conveniently manipulate the third manipulation unit 130c and the fourth manipulation unit 130d while gripping the distance measuring apparatus 100.

In the exemplary embodiment, the distance measuring apparatus 100 may be applied with power upon receiving a user input of pressing the third manipulation unit 130c. In the exemplary embodiment, the distance measuring apparatus 100 may measure the distance to a target while the user presses the fourth manipulation unit 130d. Specifically, the distance measuring apparatus 100 may measure the distance by emitting a laser while the user presses the fourth manipulation unit 130d. When the user stops the operation of pressing the fourth manipulation unit 130d, the distance measuring apparatus 100 may stop emitting the laser and measuring the distance to the target. However, the present disclosure is not limited thereto, and the distance measuring apparatus 100 may perform power application and laser emission for distance measurement in response to a user input of pressing the third manipulation unit 130c.

At least one objective lens 122 and 123 may be disposed in the rear case 103. The objective lenses 122 and 123 may receive light from the outside, or may emit a laser to the outside. For example, the objective lens 122 located at the upper side may receive light from a subject, allowing a user to visually identify the subject through the eyepiece 121. Additionally, the objective lens 123 located at the lower side may emit a laser toward a target, and the objective lens 122 located at the upper side may receive the reflected laser when the laser emitted by the distance measuring apparatus 100 is reflected by the target.

These configurations are not limited to these arrangements. The configurations may be excluded, replaced, or arranged on other sides as desired. For example, the front face of the body may not be provided with the display portion 151a and the second manipulation unit 130b, and the number of manipulation units 130a, 130b, 130c, and 130d may be varied. Furthermore, the distance measuring apparatus 100 may perform a plurality of functions through one manipulation unit.

Next, with reference to FIG. 4, the optical unit 120 and the distance measurement sensor 111 of the distance measuring apparatus 100 will be described in detail.

FIG. 4 is a schematic structural diagram of the distance measuring apparatus according to the exemplary embodiment. Specifically, FIG. 4 is a schematic structural diagram of the optical unit 120 and the distance measurement sensor 111 of the distance measuring apparatus 100 according to the exemplary embodiment.

Referring to FIG. 4, the distance measuring apparatus 100 according to the exemplary embodiment may include two objective lenses 122 and 123 and one eyepiece 121, an optical path changing unit 126, an optical processing unit 124, a display unit 151b, a laser receiving unit 1110, a laser generation unit 1111, a laser control unit 1112, a measured distance calculating unit 200, and a control unit 180.

Through the first objective lens 122, external light OL may be incident on the distance measuring apparatus 100, or a laser L1 reflected from a target may be incident. The path of the laser L1 incident through the first objective lens 122 may be changed through the optical path changing unit 126 to face the laser receiving unit 1110.

External light OL may be incident on the light processing unit 124 via the first objective lens 122 and the optical path changing unit 126. The light processing unit 124 may include a lens unit and a filter unit. The external light OL incident on the light processing unit 124 may be optically processed and directed toward the eyepiece 121.

The display unit 151b may be formed of a transparent or translucent display, which may be disposed directly in the path through which the external light OL passes. The display unit 151b may display an image to a user through the eyepiece 121 of the distance measuring apparatus 100. The internally disposed display unit 151b may include a transparent display (or translucent display) disposed directly in the optical path of the eyepiece 121. Representative examples of the transparent display include a transparent OLED (TOLED). The internally disposed display unit 151b may also be an opaque display that provides an image to the optical path of the eyepiece 121 through a translucent member having a function of refracting or reflecting light and the like.

The laser receiving unit 1110 may receive the laser L1 incident through the first objective lens 122 and output a corresponding signal to the measured distance calculating unit 200. The measuring distance calculating unit 200 may calculate a distance from the distance measuring apparatus 100 to the target by using the received signal.

The control unit 180 may detect hand tremor of a user using the distance measuring apparatus 100, and may measure a hand tremor period and a hand tremor angle. The laser control unit 1112 may receive the hand tremor period of the user from the control unit 180 and may control an output section of the laser emitted from the distance measuring apparatus 100 based on the hand tremor period of the user. In the exemplary embodiment, the laser control unit 1112 may control the output section of the laser emitted from the distance measuring apparatus 100 to include the hand tremor period of the user. The measured distance calculating unit 200 may receive the hand tremor angle of the user from the control unit 180 and may take the hand tremor angle of the user into account when calculating the distance to the target.

The measuring distance calculating unit 200 may calculate a distance from the distance measuring apparatus 100 to the target. When the measured distance calculating unit 200 calculates the distance to the target, the measured distance calculating unit 200 may take into account straight-line distance information received from the laser receiving unit 1110, the tilt of the distance measuring apparatus 100 received from the control unit 180, and the like. The measured distance calculating unit 200 may calculate the height information from the distance measuring apparatus 100 to the target based on the tilt information of the distance measuring apparatus 100 received from the control unit 180. The measured distance calculating unit 200 may further consider the hand tremor angle of the user received from the control unit 180 when calculating the distance to the target. Thus, an error value of the distance information due to the hand tremor of the user may be reduced.

The laser control unit 1112 may control a laser L2 emitted by the laser generation unit 1111. Given that lasers cause damage to the retina when they are implanted in the retina, there are stability standards for laser products. These stability standards are stipulated in IEC60825 (International Electro-technical Commission (IEC)). The laser control unit 1112 may control the laser L2 emitted from the laser generation unit 1111 to meet the stability standards. Specifically, in order to satisfy the stability standards, the laser output from the distance measuring apparatus 100 needs to repeat the output section and the non-output section, and the total output time of the laser output while the distance measuring apparatus 100 is measuring the distance needs not exceed a predetermined time. Accordingly, the laser control unit 1112 may determine an initial output section of the laser based on the hand tremor period of the user received from the control unit 180, and may control the remaining output section, period, and number of times of the laser output based on the determined initial output section of the laser.

The laser generation unit 1111 may transmit a laser for distance measurement. The laser L2 generated by the laser generation unit 1111 may be output to the outside through the second objective lens 123.

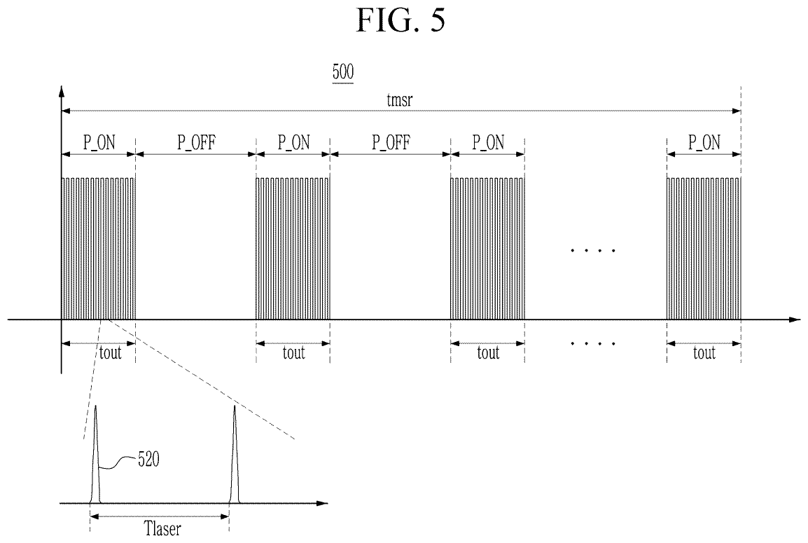

FIG. 5 is a diagram for illustrating the output section and output period of a laser output from the distance measuring apparatus 100. Specifically, FIG. 5 is a graph 500 illustrating the output section and period of laser output from the distance measuring apparatus 100 while measuring a distance to a target by using the distance measuring apparatus 100.

Upon receiving an input from a user, the distance measuring apparatus 100 may output a laser to measure a distance to a target while receiving the user input.

While the user presses the button (e.g., 130c or 130d in FIG. 2) to measure the distance, the maximum measurement time tmsr during which the distance measuring apparatus 100 outputs the laser to measure the distance may be a predetermined time. That is, even when the user continues to press the button to measure the distance, when the predetermined maximum measurement time tmsr has elapsed, the distance measuring apparatus 100 may stop outputting the laser and output the measured distance information. In this case, the output distance information may be shortest distance information among the distance information measured during the maximum measurement time tmsr.

According to the stability standards stipulated in IEC60825 and the like, the laser emitted by the distance measuring apparatus 100 during the maximum measurement time tmsr for distance measurement may repeat a laser output section P_ON and a laser non-output section P_OFF. The laser output section P_ON may be a time section formed by repeating an output pulse 520 of the laser at a constant period Tlaser. During the laser output section P_ON, the laser generation unit (1111 in FIG. 4) may output the laser (L2 in FIG. 2) through the second objective lens (123 in FIG. 4). According to the stability standards stipulated in IEC60825 and the like, the total time (Σtout) during which the laser is output during the maximum measurement time tmsr during which the distance measuring apparatus 100 measures the distance to the target cannot exceed a predetermined time (e.g., 750 ms). The total time (tout) during which the laser is output during the maximum measurement time tmsr may refer to the sum of the time length of each laser output section P_ON. For example, upon receiving a button input or the like from the user to perform distance measurement, the distance measuring apparatus 100 may repeat the laser output section P_ON and the laser non-output section P_OFF for the maximum measurement time tmsr from the time point of the initial laser generation, and the total time (Σtout) during which the laser is output during the maximum measurement time tmsr needs to satisfy a predetermined time range.

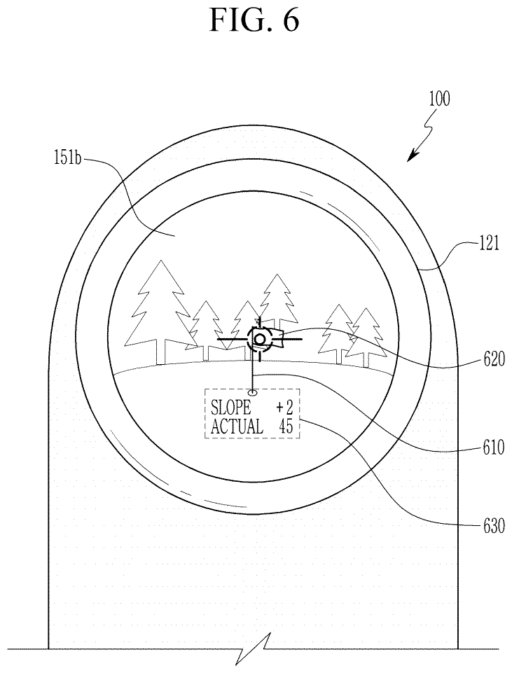

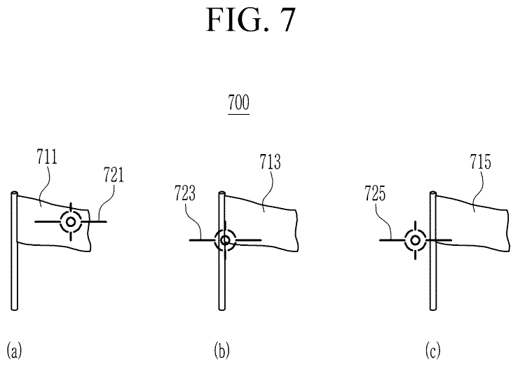

FIGS. 6 and 7 are diagrams illustrating a target point and a target displayed on the distance measuring apparatus. Specifically, the display unit 151b of the distance measuring apparatus 100 may display the image illustrated in FIG. 6 to the user through the eyepiece 121.

Referring to FIG. 6, when the user finds a target 610, the user may aim the target 610 through the eyepiece 121 of the distance measuring apparatus 100 and press the button 130c or 130d to cause the distance measuring apparatus 100 to perform a distance measuring operation. By the button input operation of the user, a target indicator 620 indicating the target point may be displayed on the display unit 151b. In some exemplary embodiments, in the state where the target indicator 620 is displayed on the display unit 151b, the button input operation of the user may cause the target indicator 620 to be highlighted and displayed.

The distance measuring apparatus 100 may output a laser to the target point to measure the distance to the target, and may display measured distance information 630 on the display unit 151b based on the time the laser reflects back from the target point.

In this case, the distance measuring apparatus 100 may repeat the output section in which a laser is output and the non-output section in which a laser is not output to satisfy the stability standards, and display shortest distance information among the distance information measured during the output section on the display unit 151b.

However, since the distance measuring apparatus 100 is operated by a human hand rather than fixed mounting, the hand tremor of the user may reduce the accuracy of the distance measurement.

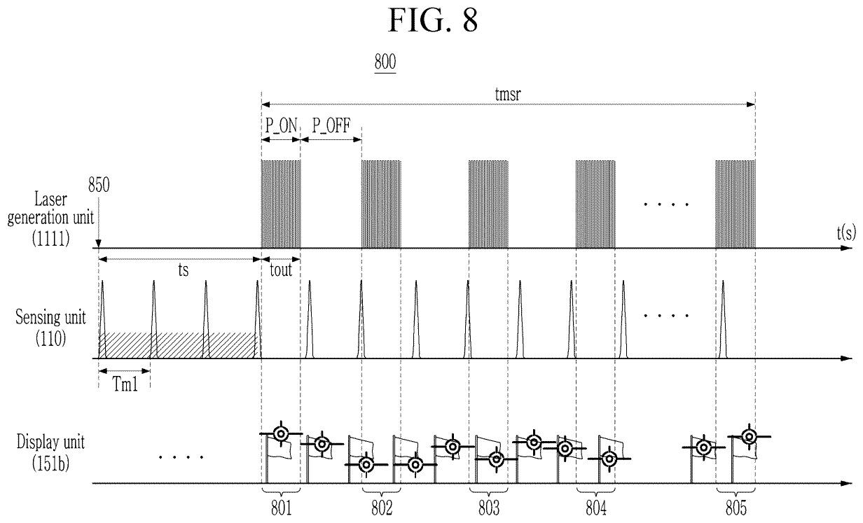

Referring now to FIG. 7, FIG. 7 is a diagram to illustrate a target point caused by the hand tremor of the user. The user's operations, such as pressing a button, may cause hand tremors, and the target point may change due to the hand tremor of the user. For example, in (a) and (b) of FIG. 7, the target indicators 721 and 723 are aimed at targets 711 and 713, but in (c) of FIG. 7, the target indicator 725 cannot be aimed at a target 715. When the distance measuring apparatus 100 is aimed at the target as in (c) in the output section, the user may not be able to acquire accurate distance information from the distance measuring apparatus 100. That is, the hand tremor of the user may cause an error between the distance information output by the distance measuring apparatus 100 and the actual distance from the distance measuring apparatus 100 to the target. An operation method of the distance measuring apparatus 100 according to a comparative example will be described in more detail with reference to FIG. 8.

FIG. 8 is a diagram illustrating a laser output from the distance measuring apparatus 100 and a distance measuring method based on the output laser according to a comparative example.

At a first timing 850, the distance measuring apparatus 100 may receive a first user input of pressing a button (e.g., 130c in FIG. 2) from a user.

When the first user input is received, the sensing unit 110 may detect movement of the distance measuring apparatus 100 at a constant period Tm1. Here, the sensing unit 110 may refer to an acceleration sensor (113 in FIG. 1) that acquires a degree of tilt of the distance measuring apparatus, an azimuth sensor (114 in FIG. 1) that measures an azimuth angle facing the distance measuring apparatus, a gyro sensor that measures a rotation angle of the distance measuring apparatus, and the like. The sensing unit 110 may measure the tilt, azimuth angle, and the like of the distance measuring apparatus according to the movement of the user at the constant period Tm1 until the power of the distance measuring apparatus 100 is cut off or the distance measurement is completed.

When the first user input is received, the sensing unit 110 may measure the tilt, azimuth, or the like of the distance measuring apparatus 100 to determine whether the distance measuring apparatus 100 is aimed at the target. Since the distance measuring apparatus may be applied with power even when the user does not intend to measure the distance, such as by pressing a button attached to the distance measuring apparatus while the user is moving, the sensing unit may determine whether the distance measuring apparatus 100 is aimed at the target for a predetermined time ts to determine whether the user intends to measure the distance.

When the first user input is received, the sensing unit 110 may measure the tilt, azimuth, or the like of the distance measuring apparatus 100, to acquire data, such as a tilt value or an azimuth value, of the distance measuring apparatus 100. The data acquired by the sensing unit 110 may be used to calculate a distance from the distance measuring apparatus 100 to the target.

When the distance measuring apparatus 100 aims the direction of the target and receives a button input (e.g., 130c or 130d in FIG. 2) from the user at a second timing 852, the laser generation unit 1111 of the distance measuring apparatus 100 may output a laser. As described above in FIG. 5, the laser emitted by the distance measuring apparatus 100 may repeat a laser output section P_ON and a laser non-output section P_OFF in accordance with the stability standards stipulated in IEC60825 or the like. In this case, the laser output section P_ON and the laser non-output section P_OFF may be repeated at a predetermined time and a predetermined number of times. Furthermore, according to the stability standards stipulated in IEC60825 and the like, the total time (Σtout) during which the laser is output, that is, the total sum of the time lengths of the laser output sections P_ON, cannot exceed a predetermined time (e.g., 750 ms).

The display unit 151b may output a target indicator while the distance measuring apparatus 100 outputs a laser. During the maximum measurement time tmsr in which the distance measuring apparatus 100 performs a distance measuring operation, the laser may be output in a first section 801, a second section 802, a third section 803, a fourth section 804, and a fifth section 805, and the like. The distance measuring apparatus 100 may output the shortest distance information among the distance information measured in each of the sections 801, . . . , and 805 of outputting the laser as final distance information.

However, as described above in FIGS. 6 and 7, since the user controls the laser to be output from the distance measuring apparatus by pressing the button attached to the distance measuring apparatus, the target point may change continuously due to the hand tremor of the user. Accordingly, there may be no time point at which the target point and the target coincide among the sections 801, . . . , and 805 in which the distance measuring apparatus 100 outputs a laser. As illustrated in FIG. 8, when there is no time point at which the target and the target point coincide while performing the distance measurement, the distance measuring apparatus cannot output accurate distance information. This problem is exacerbated as the distance between the target and the distance measuring apparatus increases.

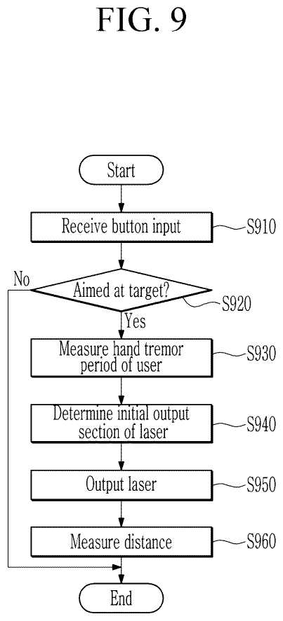

FIG. 9 is a diagram illustrating the distance measuring method of the distance measuring apparatus according to an exemplary embodiment. The distance measuring apparatus 100 according to the exemplary embodiment may control an initial output section of the laser to facilitate a user to easily aim a target point at a target.

First, the distance measuring apparatus 100 may receive a first user input of pressing a button (e.g., 130c in FIG. 2) from a user (S910).

When the first user input is received, the distance measuring apparatus 100 may determine whether the distance measuring apparatus is aimed at a target (S920). The acceleration sensor 113, the azimuth sensor 114, the gyro sensor, and the like in the distance measuring apparatus 100 may determine whether the distance measuring apparatus 100 is aimed at the target through the tilt, azimuth value, and the like of the distance measuring apparatus 100.

When it is determined that the distance measuring apparatus 100 is aimed at the target, the distance measuring apparatus 100 may detect a hand tremor of the user by using the hand tremor sensor 115 and measure a hand tremor period (S930). The hand tremor sensor 115 may detect the hand tremor of the user caused by the user pressing the button and measure the hand tremor period. The hand tremor sensor 115 may further measure the angle of the hand tremor of the user. To measure the hand tremor period of the user, the hand tremor sensor 115 may acquire hand tremor data of the user at a predetermined period. To measure the hand tremor period of the user, the hand tremor sensor 115 may acquire the hand tremor data of the user for a predetermined time.

When the hand tremor period of the user is measured, the distance measuring apparatus 100 may determine an initial output section of the laser output from the distance measuring apparatus 100 (S940). The laser control unit (1112 in FIG. 4) in the distance measuring apparatus may determine the hand tremor period of the user as the initial output section of the laser. The laser control unit 1112 may determine a time length that is longer than the hand tremor period of the user as the initial output section of the laser. By ensuring that the time length of the initial output section of the laser is equal to the hand tremor period of the user or includes the hand tremor period of the user, the distance measuring apparatus 100 may be accurately aimed at the target during the initial output section of the laser.

When a second user input pressing a button (e.g., 130c or 130d in FIG. 2) is received from a user, the distance measuring apparatus 100 may output a laser (S950). The laser control unit 1112 within the distance measuring apparatus 100 may determine an initial output section of the laser, and may determine the remaining output section and the number of times the laser is to be output to meet the safety certification standards. When the laser control unit 1112 determines the remaining output time and the number of times of the laser output, the laser generation unit 1111 may output the laser.

When the laser is output, the distance measuring apparatus 100 may receive the laser reflected by the target, and may measure a distance between the distance measuring apparatus 100 and the target (S960). The measured distance calculating unit (200 in FIG. 4) of the distance measuring apparatus 100 may consider various data received from the sensing unit (110 in FIG. 1) to measure the distance between the distance measuring apparatus 100 and the target. The various data received from the sensing unit (110 of FIG. 1) may include a tilt and an azimuth angle of the distance measuring apparatus 100, and a hand tremor angle of the user. The various data received from the sensing unit (110 in FIG. 1) may be information for measuring height information from the distance measuring apparatus 100 to the target.

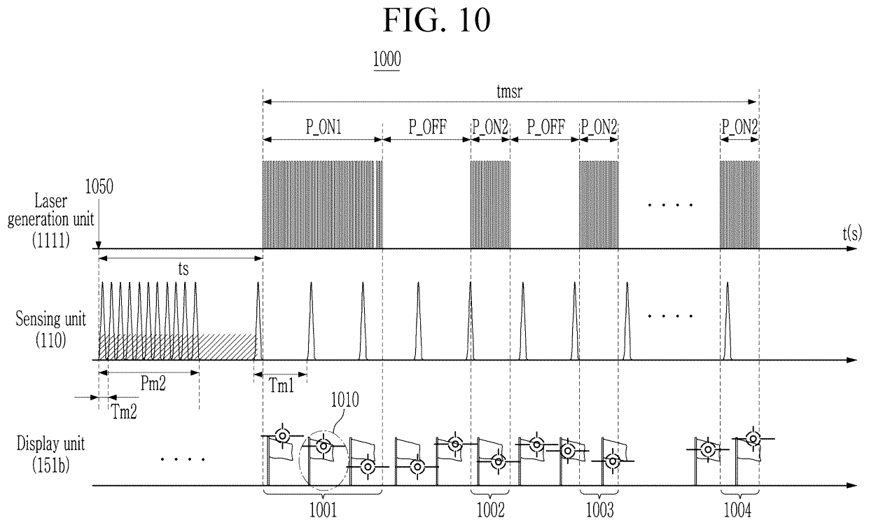

FIG. 10 is a diagram illustrating a laser output from the distance measuring apparatus 100 and a distance measuring method based on the output laser according to an exemplary embodiment.

At a first timing 1050, the distance measuring apparatus 100 may receive a first user input of pressing a button (e.g., 130c in FIG. 2) from a user.

When the first user input is received, the sensing unit 110 may determine whether the distance measuring apparatus 100 is aimed at a target and may measure a hand tremor period of the user at a predetermined period Tm2 during a predetermined section Pm2. The predetermined section Pm2 is illustrated as a period within a predetermined time ts for determining whether the distance measuring apparatus 100 is aimed at the target, but the hand tremor sensor 115 may measure the hand tremor period of the user even after the predetermined time ts has elapsed. When the hand tremor period of the user is measured, the sensing unit 110 may detect the movement of the distance measuring apparatus 100 at a constant period Tm1, and may measure the tilt, azimuth, or the like of the distance measuring apparatus 100. In the exemplary embodiment, the operation period Tm2 of the sensing unit 110 for measuring the hand tremor period of the user may be shorter than the operation period Tm1 for measuring the tilt, azimuth, and the like of the distance measuring apparatus 100. The tilt, azimuth, and the like of the distance measuring apparatus 100 measured at the constant period Tm1 may be used to calculate the distance to the target.

When the hand tremor period is measured, the laser control unit 1112 of the distance measuring apparatus 100 may determine an initial output section P_ON1 of the laser.

At a second timing 1052, the distance measuring apparatus 100 may receive a second user input of pressing the button (e.g., 130c or 130d in FIG. 2) from a user.

When the second user input is received, the laser generation unit 1111 may output a laser during the initial output section P_ON1 determined by the laser control unit 1112. The initial output section P_ON1 of the laser output by the laser generation unit 1111 may include a hand tremor period of the user. For example, when the hand tremor period of the user is measured by the hand tremor sensor 115 to be 125 ms (e.g., the hand tremor frequency is 8 Hz), the laser control unit 1112 may determine a time length greater than 125 ms as the initial output section P_ON1 of the laser.

During the persistence of the second user input, the laser generation unit 1111 may repeat the laser output sections P_ON1 and P_ON2 and the laser non-output section P_OFF within the range of the maximum measurement time tmsr. When the initial output section P_ON1 of the laser is determined, the laser control unit 1112 may determine the remaining output section P_ON2 and the non-output section P_OFF and the number of times the remaining output section P_ON2 and the non-output section P_OFF are repeated. The remaining output section P_ON2 and the non-output section P_OFF, and the number of times the remaining output section P_ON2 and the non-output section P_OFF are repeated, may be sections determined by considering the total output time in accordance with the stability standards stipulated in IEC60825 or the like. In the exemplary embodiment, the remaining output section P_ON2 may be repeated at constant periods. In the exemplary embodiment, the period of the remaining output section P_ON2 may be predetermined based on the total output time. In the exemplary embodiment, the remaining output sections P_ON2 may be the same or different from each other.

Turning to the display unit 151b, the display unit 151b may output the target and a target indicator while the distance measuring apparatus 100 performs the distance measuring operation. During the maximum measurement time tmsr in which the distance measuring apparatus 100 performs the distance measuring operation, the laser may be output in a first section 1001, a second section 1002, a third section 1003, a fourth section 1004, and the like.

Meanwhile, due to the hand tremor of the user, the target point may change continuously. However, since the initial output section P_ON1 of the laser includes the hand tremor period of the user, the initial output section P_ON1 of the laser may include a time point 1001 when the target point is aimed at the target. As such, by ensuring that the initial output section P_ON1 of the laser includes the hand tremor period of the user, the distance measuring apparatus 100 may be accurately aimed at the target with the laser. Thus, the accuracy of the distance information output by the distance measuring apparatus 100 may be increased.

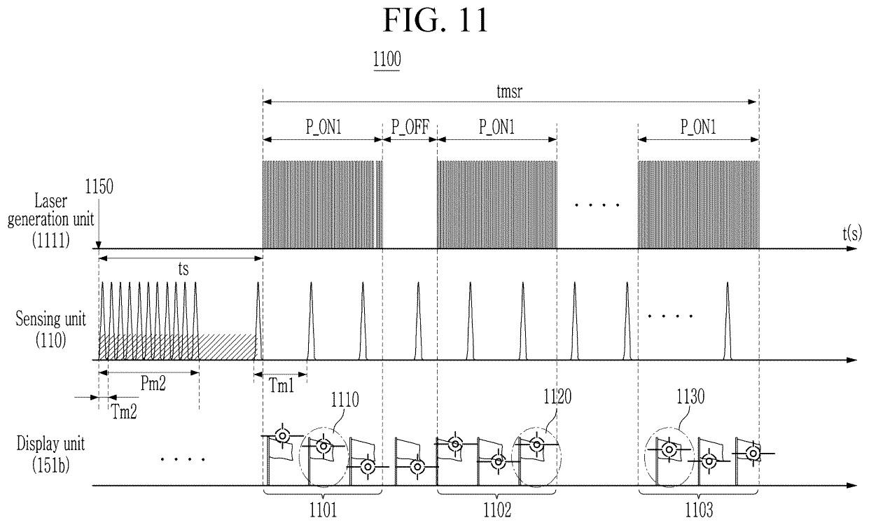

FIG. 11 is a diagram illustrating a laser output from the distance measuring apparatus 100 and a distance measuring method based on the output laser according to an exemplary embodiment. Specifically, FIG. 11 is a diagram illustrating an exemplary embodiment in which all output sections of the laser include the hand tremor period of the user.

With respect to FIG. 11, the description of the same or similar operation as in FIG. 10 will be omitted.

In the exemplary embodiment, when the hand tremor sensor 115 measures the hand tremor period of the user, the laser control unit 1112 of the distance measuring apparatus 100 may determine the output section P_ON1 of the laser. The output section P_ON1 of the laser output by the laser generation unit 1111 may include the hand tremor period of the user. For example, when the hand tremor period of the user is measured by the hand tremor sensor 115 to be 100 ms (10 Hz), the laser generation unit 1111 may output a laser for a time length greater than 100 ms. The laser control unit 1112 may determine the number of laser output sections P_ON1 and a non-output section P_OFF based on the total output time of the laser in accordance with safety certification standards. The laser generation unit 1111 may repeat the laser output section P_ON1 and the laser non-output section P_OFF according to the instructions of the laser control unit 1112. The laser output sections P_ON1 and P_ON2 and the laser non-output section P_OFF may be repeated for the maximum measurement time tmsr.

Turning to the display unit 151b, the display unit 151b may output the target and a target point while the distance measuring apparatus 100 performs the distance measuring operation. During the maximum measurement time tmsr in which the distance measuring apparatus 100 performs the distance measuring operation, the laser may be output in a first section 1101, a second section 1102, and a third section 1103, and the like.

Meanwhile, due to the hand tremor of the user, the target point at which the laser is aimed at the target may change continuously. However, since each of the sections 1101, 1102, and 1103 during which the laser is output includes the hand tremor period of the user, the sections 1101, 1102, and 1103 may include time points 1110, 1120, and 1130 at which the distance measuring apparatus 100 is aimed at the target, respectively. Thus, the distance measuring apparatus 100 may be accurately aimed at the target with the laser, which has the advantage of increasing the accuracy of the distance information output by the distance measuring apparatus 100.

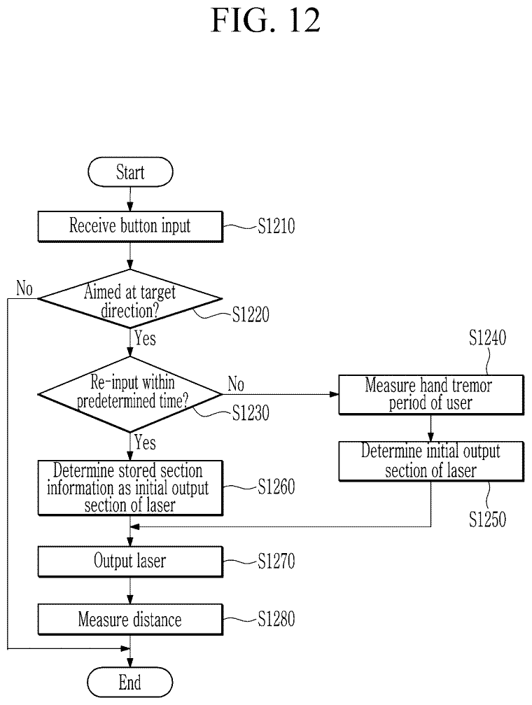

FIG. 12 is a diagram illustrating a distance measuring method of the distance measuring apparatus according to another exemplary embodiment. With respect to the distance measuring method of FIG. 12, the description of the same or similar description as in FIG. 9 will be omitted.

First, the distance measuring apparatus 100 may receive a button input from a user (S1210).

When the button input is received from the user (e.g., 130c or 130d in FIG. 2), the distance measuring apparatus 100 may determine whether the user input is a re-input within a predetermined time period from a previous distance measurement time point (S1230).

When it is determined that the user input is the re-input within the predetermined time period, the distance measuring apparatus 100 may determine the pre-stored laser output section information as a laser initial output section (S1260).

In relation to operation S1260, when the user input is received, the distance measuring apparatus 100 may measure the hand tremor period of the user and determine an output section of the laser to include the hand tremor period of the user. In this case, the output section of the laser determined based on the hand tremor period of the user may be stored in the memory (160 in FIG. 1) of the distance measuring apparatus 100. When the distance measuring apparatus 100 receives the user input again within a predetermined time period, the distance measuring apparatus 100 may determine the output section of the laser stored in the memory as the initial output section of the laser without separately measuring the hand tremor period of the user.

The distance measuring apparatus 100 may output a laser for measuring a distance from the distance measuring apparatus 100 to a target (S1270), and may measure a distance between the distance measuring apparatus 100 and the target by receiving a laser reflected by the target (S1280).

This has the advantage of providing the user with distance information to the target more quickly, by skipping the measurement of the hand tremor period of the user when the user input is received again within a predetermined time period.

While this invention has been described in connection with what is presently considered to be practical exemplary embodiments, it is to be understood that the invention is not limited to the disclosed exemplary embodiments.

What is claimed is:

1. A distance measuring apparatus comprising:
a user input unit configured to receive a first user input and a second user input;
a hand tremor sensor configured to detect a hand tremor of a user based on the first user input, and measure a hand tremor period of the user; and
a distance measurement sensor configured to determine a first laser output section based on the hand tremor period, and output a laser during the first laser output section based on the second user input.

2. The distance measuring apparatus of claim 1, wherein:
The first laser output section is equal to or longer than the hand tremor period.

3. The distance measuring apparatus of claim 1, wherein:
the distance measurement sensor configured to perform a distance measurement to a target point during a predetermined time section based on the second user input, the predetermined time section includes the first laser output section, a plurality of laser non-output sections in which the laser is not output, and a plurality of second laser output section in which the laser is output, and the plurality of laser non-output sections and the plurality of second laser output sections are alternating.

4. The distance measuring apparatus of claim 3, wherein:
a sum of time lengths of the first laser output section and the plurality of second laser output sections is predetermined, the number of the plurality of second laser output sections repeated within the predetermined time section is predetermined, and the time length of the plurality of second laser output sections is shorter than the time length of the first laser output section.

5. The distance measuring apparatus of claim 3, wherein:
a sum of time lengths of the first laser output section and the plurality of second laser output sections is predetermined, the number of the plurality of second laser output sections repeated within the predetermined time section is predetermined, and the time length of the plurality of second laser output sections is equal to the time length of the first laser output section.

6. The distance measuring apparatus of claim 1, wherein:
based on the hand tremor of the user, the hand tremor sensor configured to further measure a hand tremor angle.

7. The distance measuring apparatus of claim 6, wherein:
the distance measurement sensor configured to measure a distance to the target point based on a time for which at least one of output pulses of the laser output in the first laser output section is reflected back from the target point and the hand tremor angle.

8. The distance measuring apparatus of claim 3, further comprising:
a memory configured to store the hand tremor period,
wherein when the user input unit receives the second user input again before a second time section elapses after the predetermined time section, the distance measurement sensor re-determines the first laser output section based on the hand tremor period stored in the memory, and re-outputs a laser during the first laser output section based on the re-input second user input.

9. A distance measuring method comprising:
receiving a first user input;
detecting an aiming direction of a distance measuring apparatus based on the first user input;
based on the aiming direction, detecting a hand tremor of a user, and measuring a hand tremor period at a first predetermined period;
determining a first laser output section based on the hand tremor period;
receiving a second user input;
outputting a laser during a plurality of laser output sections including the first laser output section based on the second user input; and
measuring a distance to the target point based on a time for the output laser to reflect back from the target point.

10. The distance measuring method of claim 9, wherein:
the determining of the first laser output section based on the hand tremor period includes:
determining a time length equal to the hand tremor period or greater than the hand tremor period as the first laser output section; and
determining a time length of the remaining output sections among the plurality of laser output sections, except for the first laser output section.

11. The distance measuring method of claim 10, wherein:
the outputting of the laser during the plurality of laser output sections including the first laser output section based on the second user input includes
outputting the laser during the first laser output section, and alternating with a plurality of laser non-output sections in which the laser is not output and the remaining output sections, within a predetermined time section.

12. The distance measuring method of claim 10, wherein:
the remaining output sections are the same as the first laser output section.

13. The distance measuring method of claim 9, further comprising:
measuring a tilt and an azimuth of the distance measuring apparatus at a second predetermined period different from the first predetermined period.

14. The distance measuring method of claim 13, wherein:
the first predetermined period is shorter than the second predetermined period.

15. The distance measuring method of claim 9, further comprising:
measuring a hand tremor angle based on the hand tremor of the user.

16. The distance measuring method of claim 9, further comprising:
receiving a second user input again;
determining when the re-received second user input is an input within a predetermined time section after the distance measurement; and
when it is determined that the re-received second user input is an input within a predetermined time section after the distance measurement, re-determining the first laser output section based on the hand tremor period.

17. A distance measuring apparatus for measuring a distance to a target point, the distance measuring apparatus comprising:
a sensing unit for detecting a hand tremor of a user at a first period, measuring a hand tremor period and a hand tremor angle, and measuring a tilt of the distance measuring apparatus at a second period different from the first period; and
a distance measurement sensor for repeating a plurality of laser output sections of outputting a laser and a plurality of laser non-output sections of not outputting a laser for a predetermined measurement time, a first output section of the plurality of laser output sections including the hand tremor period, measuring a straight line distance to the target point based on a time for a laser output in the plurality of laser output sections to reflect back from the target point, and measuring a height distance to the target point based on the tilt and the hand tremor angle.

18. The distance measuring apparatus of claim 17, wherein:
a sum of time lengths of the plurality of laser output sections repeated for the predetermined measurement time is predetermined.

19. The distance measuring apparatus of claim 18, wherein:
a time length of the first output section of the plurality of laser output sections and a time length of the remaining output sections except for the first output section of the plurality of laser output sections are different from each other.

20. The distance measuring apparatus of claim 17, wherein:
the first period is shorter than the second period.
